(19) United States
(12) Patent Application Publication
(10) Pub. No.: US 2017/0345396 A1
(43) Pub. Date: Nov. 30, 2017

(54) CONFIGURING VIRTUAL DISPLAY ZONES WITHIN ONE FLEXIBLE DISPLAY

(71) Applicant: Lenovo (Singapore) Pte. Ltd., New Tech Park (SG)

(72) Inventors: JONATHAN JEN-WEI YU, Raleigh, NC (US); AARON MICHAEL STEWART, Raleigh, NC (US); TAKUMI IMAI, Kamakura-shi (JP); KEITA ISHII, Meguro-ku (JP)

(21) Appl. No.: 15/163,048

(22) Filed: May 24, 2016

(51) Int. Cl. G09G 5/14; G06F 3/041; G06F 1/16; G09G 5/38

(52) U.S. Cl. CPC G09G 5/14; G09G 5/38; G06F 3/0412; G06F 3/0416; G06F 1/1652; G09G 2320/0626; G09G 2320/0686; G09G 2340/0492

(57) ABSTRACT

In one aspect, a device includes a processor, a display accessible to the processor, and storage accessible to the processor. The storage bears instructions executable by the processor to identify a location of at least one fold line along which the display is folded, where a first display zone is established on a first side of the fold line and a second display zone is established on a second side of the fold line. The instructions are also executable to, based on identification of the location of the at least one fold line, establish a first display mode in the first display zone and a second display mode in the second display zone, where the first display mode is different from the second display mode.

### FIELD

The present application relates generally to configuring virtual display zones within one flexible display.

### BACKGROUND

As recognized herein, flexible display technology that allows the display panel to flex is maturing. As also understood herein, currently, smart devices, operating systems, graphic systems and touch/pen controllers do not have a way to detect when and how on-screen content and display-related input/output (I/O) control (e.g., touch and pen) should be subdivided from one large display and one I/O sensor into two or more functionally discrete zones. For the case of a foldable display, this leads to the content on screen having a physical bend, making it awkward to interact with or view the content in the bend. Moreover, as also understood herein, this does not allow simultaneous, independent display-related I/O control to occur across what the user may perceive as independent interaction planes of the product (for example, interacting with both sides of a folding laptop that is positioned in tent mode). Finally, as understood herein, current smart devices and displays do not leverage sensor data in a way that fully handles the modes that will be enabled by a single foldable display.

### SUMMARY

Accordingly, in one aspect a device includes a processor, a display accessible to the processor, and storage accessible to the processor. The storage bears instructions executable by the processor to identify a location of at least one fold line along which the display is folded, where a first display zone is established on a first side of the fold line and a second display zone is established on a second side of the fold line. The instructions are also executable to, based on identification of the location of the at least one fold line, establish a first display mode in the first display zone and a second display mode in the second display zone, where the first display mode is different from the second display mode.

In another aspect, a method includes determining a location of at least one fold line in a flexible display, and virtually sub-dividing an entire area of the flexible display on which images are presentable into at least first and second virtual zones. The virtual sub-division is based at least in part on at least one of a current physical mode and the location of the at least one fold line. The method also includes establishing a first display output setting for the first virtual zone and a second display output setting for the second virtual zone.

In still another aspect, a computer readable storage medium (CRSM) that is not a transitory signal comprises instructions executable by a processor to identify a location of at least one fold line along which a foldable display is folded, where a first display zone is established on a first side of the fold line and a second display zone being established on a second side of the fold line. The instructions are also executable by the processor to establish, based on identification of the location of the at least one fold line, a first display output mode in the first display zone and a second display output mode in the second display zone, where the first display output mode is different from the second display output mode. Further, the instructions are executable by the processor to not present, based on identification of the location of the at least one fold line, an image in the fold line.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a flow chart of an example algorithm in accordance with present principles;

FIG. 4 is a perspective view of a foldable display folded into a laptop configuration, showing a sensing film on the active display portion;

FIG. 5 schematically shows additional example physical modes into which a foldable display may be moved;

FIG. 6 schematically illustrates both portrait and landscape orientations of onscreen displays based on fold zones for foldable displays;

FIG. 7 schematically illustrates various input zones and other display settings by fold zone based on fold locations for foldable displays;

FIG. 8 schematically illustrates various additional display settings by fold zone based on fold locations for foldable displays;

FIG. 9 schematically illustrates various task view and task button location differences between a foldable display configured in a clamshell mode versus book mode; and

FIG. 10 schematically illustrates maximizing differences as between book mode and laptop mode.

### DETAILED DESCRIPTION

As still further understood by the present application, when manipulating a product with a foldable display into different physical modes (e.g., tablet mode to clamshell/laptop mode), it may be beneficial to position on-screen content and modify handling of display-related input/output (I/O) based on virtual divisions naturally defined by the fold regions of the display.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

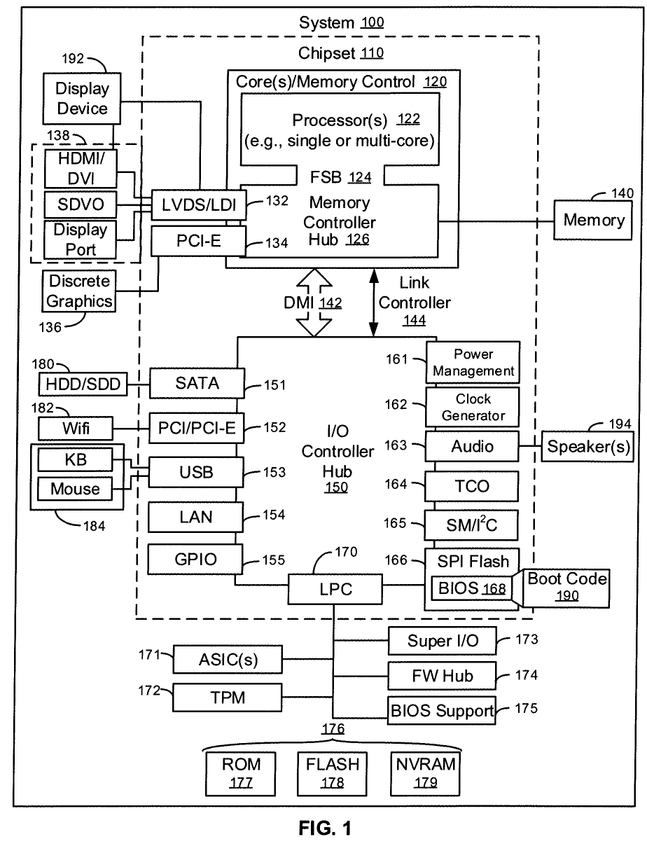

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192. In examples, the display device 192 may be a touch-enabled display that can be folded and thus that is flexible, such as but not limited to a flexible e-paper display, an organic light emitting diode (OLED) display, organic thin film transistor (OTFT) display, organic user interface (OUI) display, etc.

Block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

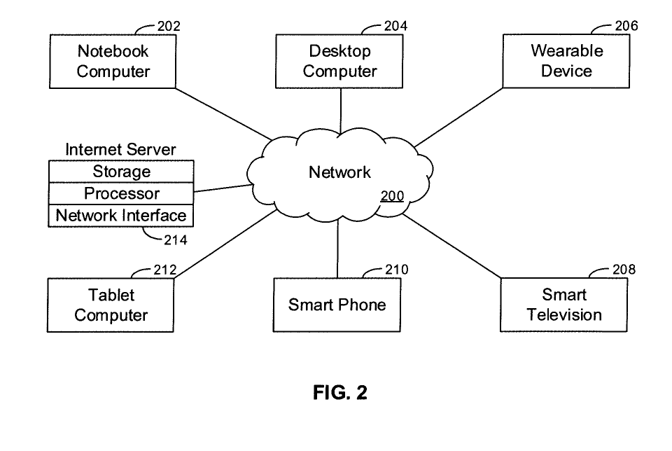

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

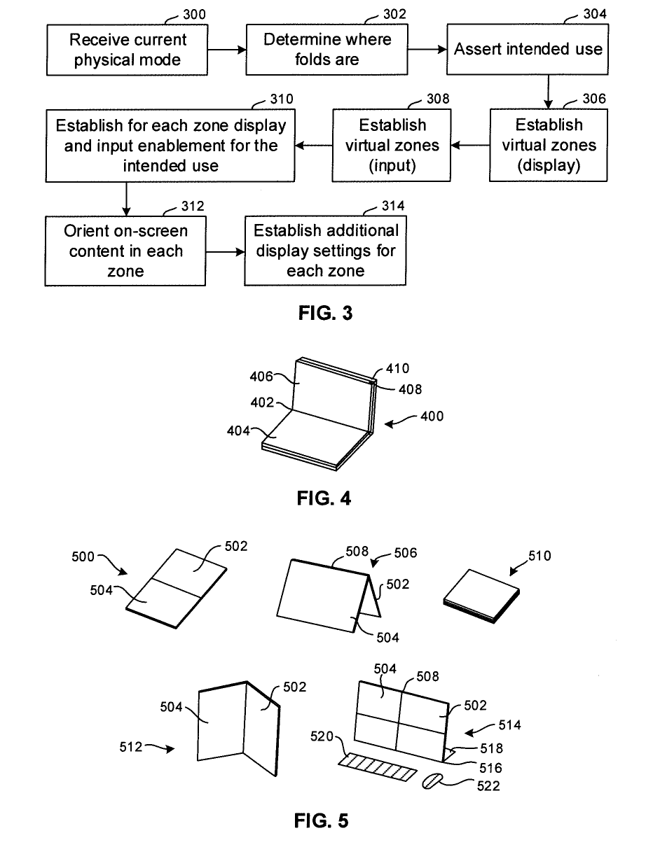

Referring to FIG. 3, example logic is shown that may be executed by a device such as any in the system 100 in accordance with present principles (referred to when describing FIG. 3 as the “present device”). Beginning at block 300, the logic identifies a current physical mode of a foldable or flexible display such as the display device 192 described above. The current physical mode may be any of the non-limiting examples shown in FIGS. 4 and 5 described below. At block 302, it is determined where the fold lines are in the display. Fold lines may be established by creases in the display, may be established by apices of curves in the display, or may be established by the curves themselves. An intended use is asserted at block 304 based on the physical mode and fold lines in blocks 300 and 302.

Proceeding to block 306, virtual display zones are established for the display by virtually sub-dividing the entire on-screen area of the display into virtual zones, based on one or more of the inputs and assertions of blocks 300-304. As disclosed further below, each display zone may have display output settings unique to that zone such that different display zones can have differing display output settings.

Moving to block 308, virtual input modes (such a touch input and pen input) may also be established for the display, again by virtually sub-dividing the sensing regions of the display into virtual zones thereby allowing simultaneous input across these zones. Then, at block 310, for each zone enablement is established or determined for the intended use. For example, one zone may be designated to display nothing (display content off) and also accept no input (input off). This may be appropriate for display zones that are on the fold lines. Another zone may be designated display content off with input on (input enabled), whereas a third zone may be designated with content display enabled and input not enabled, and a fourth zone may be designated with both display and input enabled.

The virtual zones and their respective settings may be determined by forced invocation through a graphical user interface (GUI), hardware, or other control. That is, when fold-lines are pre-established for example and not arbitrarily set by a user, the locations of these lines is known, and hence the regions of the various zones and the settings for those zones may be established in advance depending on, for example, what specific GUI the user wishes to invoke.

Or, the virtual zones and their respective settings may be pre-configured zone assignments based on the sensed physical mode and orientation of the display. Yet again, a real-time determination of the locations of the virtual zones and each zone's settings may be based on specific combinations of one or more of the following: physical mode and orientation of the device as determined by orientation sensors and fold line (pressure or touch) sensors; how a device is being held or gripped as determined by pressure or touch sensors (where content may not be presented and pen input may be ignored in zones being held); where folds are occurring in the display; current user profile/preferences as determined by user login or face recognition from images of a camera on the device and subsequent lookup of preferences for that user; and how many users are present as indicated by direct user input or image recognition from a camera on the device.

In general, various zones of the display may be apportioned content in the same manner as content is apportioned in multi-display computer systems, in which the content is divided up between multiple zones of a display instead of between multiple displays. With an OLED in particular, because individual pixels are individually addressable there may be “dead” regions of no content at the folds (or not) and the pixels for the different zones can be controlled individually to present different contents.

If desired, at block 312 on-screen display content within each virtual zone in which display content is enabled can be oriented based on the information from blocks 300-304. For example, depending on how the display is folded, text may be presented in landscape in one zone and portrait in another.

Block 314 indicates that additional display settings for each zone may be established as described further below. These settings may be automatically established based on one or more of the sensed physical modes, fold line locations, and intended use determined at blocks 300-304 or may be established by a user appropriately touching user interface selectors presented on the display. Example settings that may be established for each virtual zone independently of the same settings established for other virtual zones of the display include whether the zone's back light and/or pixels are completely disabled or enabled, and the display brightness for each zone. Additional example zone-by-zone settings include, for each zone, orientation and size of display content, enable or disable touch input for the zone, and permissions for each zone. For example, in the “yoga” mode described below, a first zone that faces a first user may be designated an admin permission zone with wide permissions to access information in the device while a second zone that faces a second user may be designated a guest permission zone with restricted permissions to access information in the device. Application switching can be managed per zone and application/window position and size can be managed per zone. Similarly, UI elements can be managed per zone. For example, duplicated taskbars may be provided for all zones.

Now referring to FIG. 4, a foldable display 400 is shown in a laptop configuration, in which the display has been folded along a fold line 402 to establish a bottom zone 404 for placement flat on a surface and an upper zone 406 facing a user who normally would be sitting in front of the display. In an example, the display 400 includes an active layer 408, e.g., an OLED layer, and lying flush against the active layer, one or more sensing layers 410. The sensing layer 410 may be located behind (relative to the normal direction of viewing) the active layer 408 as shown or, if transparent, may be located in front of the active layer.

Note that while FIG. 4 contemplates a pressure sensing film (among other sensor types) that can be juxtaposed just below/underneath the active layer, folding as the active layer folds and thus sensing the location of pressure points from which the location of the fold 402 can be determined, in some implementations no sensing layer may be provided. For example, the display may have predefined fold lines that are not user-changeable, so the controlling processor knows a priori where the fold lines are.

While the fold 402 is depicted in FIG. 4 as a line, it is to be understood that a fold might be a tight curve, or an acute fold or crease, or other linear geometry.

Sensors used in the sensing layer or layers 410 may include but are not limited to one or more of gyroscopes, accelerometers, Hall effect switches, image sensors/cameras, ambient light sensors, and touch and pressure sensors that detect hand grip of the user and pressure sensing film in the folding display that determines where bends are currently occurring in the display.

FIG. 5 illustrates various configurations into which a flexible or foldable display might be folded. In configuration 500 the display is laid flat on a surface with first and second zones 502, 504 co-planar with each other. In configuration 506 the display is folded along a single fold line 508 in a tent-like configuration, in which the display surfaces of the first and second zones 502, 504 face away from each other and are angled obliquely with respect to the vertical axis so that two people sitting across a table from each other and facing each other may both view content on the respective zones 502, 504. In the configuration 506 shown, the edges of the zones 502, 504 that are parallel to the fold line rest on the table or other horizontal surface.

In configuration 510, the display is folded so that both zones lie flush against each other. The display may be folded so that the display surfaces face each other, in which case neither surface can be seen because both face inward to establish a shut configuration, or the display surfaces may face away from each other, so that each faces outward.

In configuration 512 the display is folded in the middle as shown and is essentially rotated 90 degrees from the tent configuration 506 to establish an open book configuration, in which the edges of the zones 502, 504 that are perpendicular to the fold line rest on a surface. The various orientations may be sensed as described by gyroscopes or accelerometers or other orientation sensor and content arranged in the zones 502, 504 accordingly.

In configuration 514 the zones 502, 504 are co-planar with each other and hence not folded about the fold line 508. Instead, the display is folded along a bottom fold line 516 that extends across both zones 502, 504 and that is parallel to and spaced from the bottom edges 518 of the zones. This holds the display zones 502, 504 above the bottom fold line 516 in the upright, side-by-side configuration shown, so that a keyboard 520 and mouse 522 may be laid on the surface in front of the display to function as input devices in what is essentially a desktop multi-screen configuration.

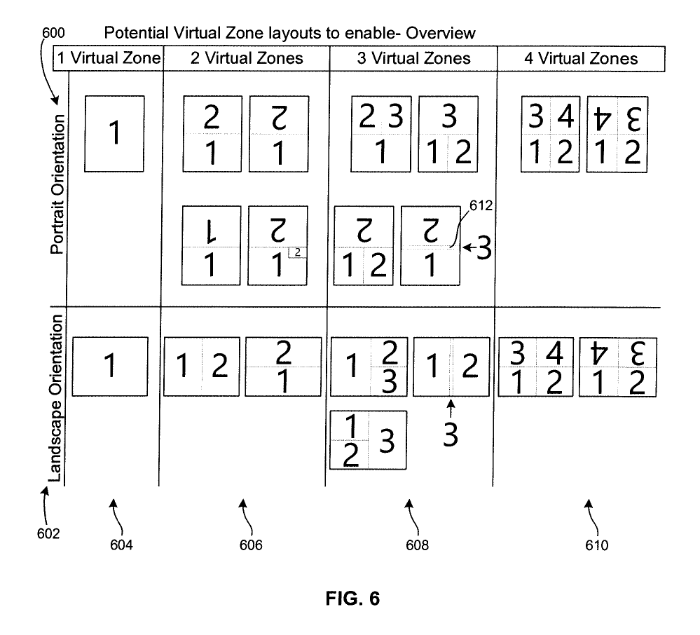

FIG. 6 shows various display layouts for varying numbers of display zones in both a portrait orientation (upper row 600), as might be used for, e.g., the open book configuration 512 in FIG. 5, and landscape orientation (bottom row 602), as might be used for, e.g., the tent configuration 506 in FIG. 5. The columns 604, 606, 608, 610 from left to right respectively illustrate example layouts for one, two, three, and four display zones. The numerals within the depicted zones indicate the number of the zone in which the numeral is shown. The direction in which each numeral is presented indicates the top and bottom orientations of images presented in the respective zone. Thus, a numeral that appears upright on the page looking down on FIG. 6 indicates that images in the respective zone would appear upright to a person seated on a first side of table while a numeral that appears upside-down on the page looking down on FIG. 6 indicates that images in the respective zone would appear upside down to the same person seated at the same first side of the table while appearing upright to another person seated across the table at the opposite second side.

The various layout depictions in FIG. 6 are now self-explanatory. Note that for a fold 612 that is not a tight crease but rather a thin roll or cylinder, a display zone “3” may be established in which certain colors or symbols or other screen images may be presented or alternatively blocked from presentation, and/or in which touch input may be selectively enabled or disabled.

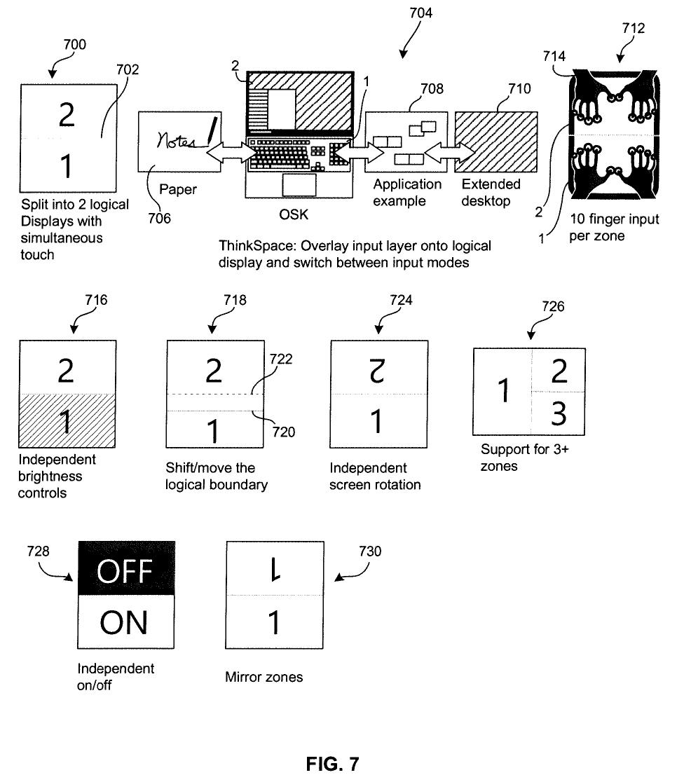

FIG. 7 shows additional schematic representations of individual display zone control, again with fold lines typically separating adjacent zones. At 700 first and second zones “1” and “2” are established responsive to a fold line 702 and/or responsive to a simultaneous touch in both zone “1” and zone “2”, with each zone being used as a logical display area to present video or text or other images independently of the opposite zone, and with touch input being enabled for both zones.

At 704 one of an example input layer 706 (a pen-based handwriting input layer) or 708 (an application user interface) or 710 (a desktop image) can be overlaid onto the bottom (first) display zone “1” while related video or text or other output display images are presented on the top (second) display zone “2”.

At 712 each of the display zones “1” and “2” is shown touch-enabled to accept ten finger input, as indicated by the hand images 714. It is to be understood that virtual keyboards may be presented in each zone with each keyboard being oriented to face the side of the table the closest user is on. Thus, in the example shown two people may sit opposite each other at a table and both may simultaneously input touch commands such as keystrokes into the display.

Reference numeral 716 indicates that a first brightness setting may be established in the first zone 1 and second, different brightness setting may be established in the second zone 2.

Reference numeral 718 indicates that the logical boundary 720 between the display zones may be shifted away from the physical fold line 722. This may be done by allowing the user to drag and drop starting (touching finger to display) at the physical fold line 722 and ending (lifting finger) at the desired location of the logical boundary 720, to enlarge (in the example shown) the second display zone “2” at the expense of the first display zone “1”.

Reference numeral 724 indicates that the orientation of images in a display zone such as zone “2” can be rotated, e.g., 180 degrees as shown to present images in the zone “2” upright to a person sitting across from a user who is located at the free edge of zone “1”. Rotation may be effected by rotating the orientation responsive to a circular finger or pen gesture made against the surface of zone “2”, in one example.

Reference numeral 726 indicates that additional zones such as a new zone “3” may be established at the expense of an existing zone such as zone “2” by, e.g., establishing the new zone responsive to a simultaneous finger touch in two locations of zone “2”.

Reference numeral 728 indicates that the display zones may be energized and deenergized independently of each other.

Reference numeral 730 indicates that two zones may be established that mirror each other by presenting images upright in one zone looking down at FIG. 7 and presenting the same images upside down in the second zone looking down at FIG. 7 (which would nevertheless appear upright to a person seated opposite the viewer).

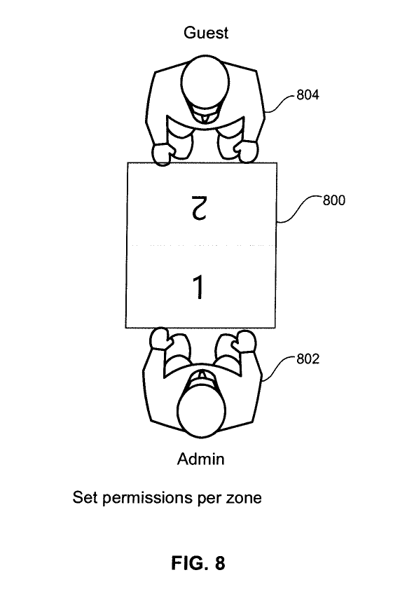

FIG. 8 illustrates that for multiple zones “1” and “2” of a display 800, each presenting images oriented to face a respective person 802, 804 as shown (as indicated by the orientations of the depicted numerals), respective user permissions may be set for each zone (and hence for each person 802, 804). Thus, a first display mode which includes a first permission setting may be established in the first display zone “1” while a second display mode which includes a second permission setting different from the first permission setting may be established in the second display zone “2”. In an example, the first permission setting may be a “guest” permission setting in which only limited data access and/or limited operational control is afforded, while the second permission setting may be an “administrator” permission setting in which unrestricted data access and/or operational control may be afforded.

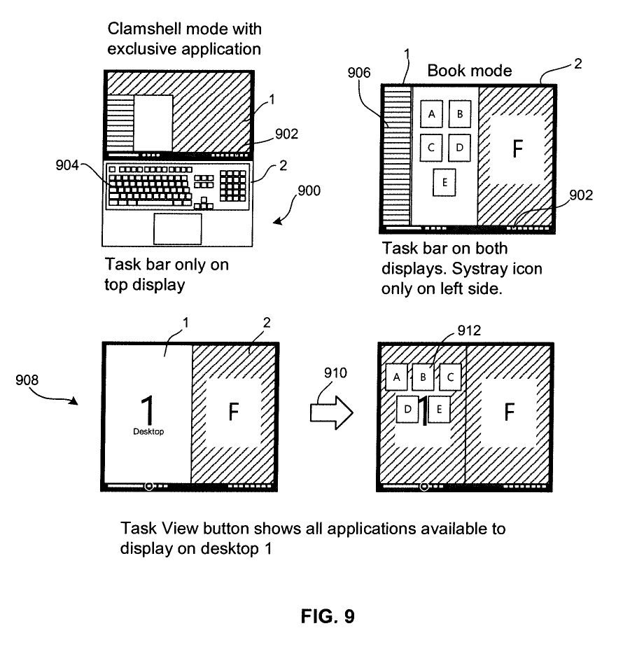

FIG. 9 illustrates various example distributions of task control input elements on multiple display zones “1” and “2”. A display 900 may be oriented in a clamshell mode in which images are presented on top and bottom zones “1” and “2” in landscape mode and in which a task bar 902 is presented only in the upper zone “1”. A virtual keyboard image 904 for keyed entry input may be presented in the lower zone “2”.

At 906 the display has been rotated 90 degrees from the orientation shown at 900 into a book mode, in which images are presented on the now left and right zones “1” and “2” in portrait mode and in which the task bar 902 is presented extending across both zones. A system tray icon group 906 is presented only in the left zone “1” and not in the right zone “2”.

Reference numeral 908 indicates that in a book mode with left and right zones “1” and “2”, a touch or other input command on a zone (e.g., zone “1”) can cause, as indicated by the arrow 910, the images presented in the zone “1” to transition to presenting application icons 912 each selectable to invoke an application for presentation in the zone “1”.

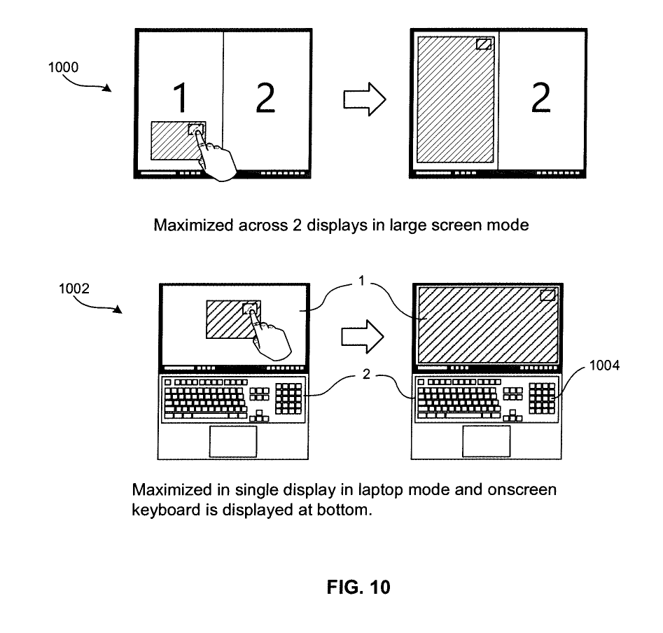

FIG. 10 illustrates at 1000 that image presentation may be maximized across both display zones “1” and “2” in a book mode orientation of the display to essentially establish a large screen mode, in which a single image is presented across both zones (i.e., the entire displayable real estate). FIG. 10 also illustrates at 1002 that in a laptop mode orientation of the display images can be maximized in the upper display zone “1” and an image 1004 of a virtual keyboard for touch input may be presented in the lower display zone “2”.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor;
a display accessible to the processor; and
storage accessible to the processor and bearing instructions executable by the processor to:
identify a location of at least one fold line along which the display is folded, a first display zone being established on a first side of the fold line and a second display zone being established on a second side of the fold line; and
based on identification of the location of the at least one fold line, establish a first display mode in the first display zone and a second display mode in the second display zone, the first display mode being different from the second display mode.

2. The device of claim 1, wherein the first display mode is a display output mode.

3. The device of claim 1, wherein the display is a touch-enabled display, and wherein the first display mode is a display input mode.

4. The device of claim 1, wherein the first display mode comprises presenting content in landscape mode and the second display mode comprises presenting content in portrait mode.

5. The device of claim 1, wherein the first display mode comprises presenting content and the second display mode comprises not presenting content.

6. The device of claim 1, wherein the first display mode comprises enabling touch input in the first display zone and the second display mode comprises disabling touch input in the second display zone.

7. The device of claim 1, wherein the first display mode comprises a first display brightness and the second display mode comprises a second display brightness.

8. The device of claim 1, wherein the first display mode comprises a first permission setting and the second display mode comprises a second permission setting.

9. The device of claim 1, wherein the first display mode comprises a first application sharing setting and the second display mode comprises a second application sharing setting.

10. A method, comprising:
determining a location of at least one fold line in a flexible display;
virtually sub-dividing an entire area of the flexible display on which images are presentable into at least first and second virtual zones, the virtual sub-division being based at least in part on at least one of a current physical mode and the location of the at least one fold line; and
establishing a first display output setting for the first virtual zone and a second display output setting for the second virtual zone.

11. The method of claim 10, comprising:
establishing a first touch input setting for the first virtual zone and a second touch input setting for the second virtual zone.

12. The method of claim 11, wherein the first touch input setting comprises enabling touch input and the second touch input setting comprises disabling touch input.

13. The method of claim 10, comprising:
identifying the current physical mode of the flexible display.

14. The method of claim 10, comprising:
predetermining the virtual zones such that the virtual zones are not set by a user.

15. The method of claim 10, comprising:
establishing the virtual zones based on a user folding the flexible display.

16. The method of claim 10, comprising:
configuring settings for each virtual zone based on identification of a physical mode and orientation of the flexible display.

17. The method of claim 10, comprising:
determining locations of the virtual zones and each zone's settings based on one or more of the following: physical mode and orientation of the device as determined based on input from at least one orientation sensor; physical mode and orientation of the device as determined based on input from at least one pressure sensor; physical mode and orientation of the device based on input from at least one touch sensor; how the flexible display is being held as determined based on input from at least one orientation sensor; how the flexible device is being held as determined based on input from at least one pressure sensor; how the flexibile display is being held as determined based on input from at least one touch sensor; where folds are occurring in the flexible display; at least one current user profile; at least one current user preference; how many users of the flexible display are present.

18. The method of claim 10, wherein the first display output setting comprises presenting content in landscape mode and the second display output setting comprises presenting content in portrait mode.

19. The method of claim 10, wherein the first display output mode comprises a first display brightness and the second display output mode comprises a second display brightness.

20. The method of claim 10, comprising:
establishing a first permission setting for the first virtual zone and establishing a second permission setting for the second virtual zone.

21. The method of claim 10, comprising:
establishing a first application sharing setting for the first virtual zone and establishing a second application sharing setting for the second virtual zone.

22. A computer readable storage medium (CRSM) that is not a transitory signal, the computer readable storage medium comprising instructions executable by a processor to:
identify a location of at least one fold line along which a foldable display is folded, a first display zone being established on a first side of the fold line and a second display zone being established on a second side of the fold line;
establish, based on identification of the location of the at least one fold line, a first display output mode in the first display zone and a second display output mode in the second display zone, the first display output mode being different from the second display output mode; and
not present, based on identification of the location of the at least one fold line, an image in the fold line.

23. The CRSM of claim 19, wherein the instructions are executable to:
establish, based on identification of the location of the at least one fold line, a first touch input mode in the first display zone and a second touch input mode in the second display zone, the first touch input mode being different from the second touch input mode.
